(19) United States
(12) Patent Application Publication
(10) Pub. No.: US 2012/0177239 A1
(43) Pub. Date: Jul. 12, 2012

(54) WIND NOISE PROTECTION

(75) Inventor: Jae Han Lee, San Jose, CA (US)

(73) Assignee: Apple Inc., Cupertino, CA (US)

(21) Appl. No.: 13/004,452

(22) Filed: Jan. 11, 2011

(51) Int. Cl. H04R 19/04

(52) U.S. Cl. 381/359

(57) ABSTRACT

A removable case for a mobile communications device includes an opening that aligns with a microphone port that is built into the device. The case includes a windscreen that is sealed across the opening of the case. The windscreen is designed to reduce wind noise, air blasts, vocal plosives, and other noise. Other embodiments are also described and claimed.

An embodiment of the invention relates to a removable case for a mobile communications device. Other embodiments are also described.

### BACKGROUND

Handheld mobile communications devices, particularly mobile phones, have enabled users to engage in real-time two-way conversations while walking, running, riding in a car, or during other activities. In a number of these situations, a user may be conducting a conversation in a noisy environment, such as outside in the wind or inside a moving car with its window down. Background noise, e.g., wind noise, can be picked up by the device's microphone and combined with the user's speech. The other party to the conversation constantly hears the background noise and thus may have difficulty understanding the user. As a result, the user often has to raise her voice and literally shout into the device's microphone to be heard.

Removable cases for mobile phones have been developed for a variety of reasons. Most mobile phone users carry their mobile phone with them wherever they go. Removable cases may have protective features that protect the mobile phone from being damaged when, for example, it is placed in a handbag. They may be designed to allow a user to affix the mobile phone to his person, e.g., a belt clip. The cases may also have aesthetic features, such as an exterior design, that allows a user of the mobile phone to express her personality.

### SUMMARY

A removable case for a handheld mobile communications device is described. The removable case includes an opening that aligns with a microphone port that is built into the device. A windscreen is sealed across the opening of the case. The windscreen is designed to reduce wind noise, air blasts, vocal plosives, and other noise. This may enable the speech of a user of the device to remain intelligible despite the presence of such noise during a call, and without requiring the user to shout into the device's microphone.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Embodiments of the invention will now be described with reference to the drawings summarized below. The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is an illustration of an example removable case that includes a windscreen for an example mobile device.

FIG. 2 is a block diagram of an example mobile device in which the removable case may be installed.

FIG. 3 is a cross-sectional view of the removable case of FIG. 1 that includes a windscreen according to an embodiment of the invention.

FIG. 4 is a cross-sectional view of the removable case of FIG. 1 that includes a windscreen according to another embodiment of the invention.

FIG. 5 is a cross-sectional view of the removable case of FIG. 1 that includes a windscreen according to yet another embodiment of the invention.

FIG. 6 is a flow chart of the operations performed to manufacture a removable case that includes a windscreen.

### DETAILED DESCRIPTION

Several embodiments of the invention with reference to the appended drawings are now explained. Whenever the shapes, relative positions, and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

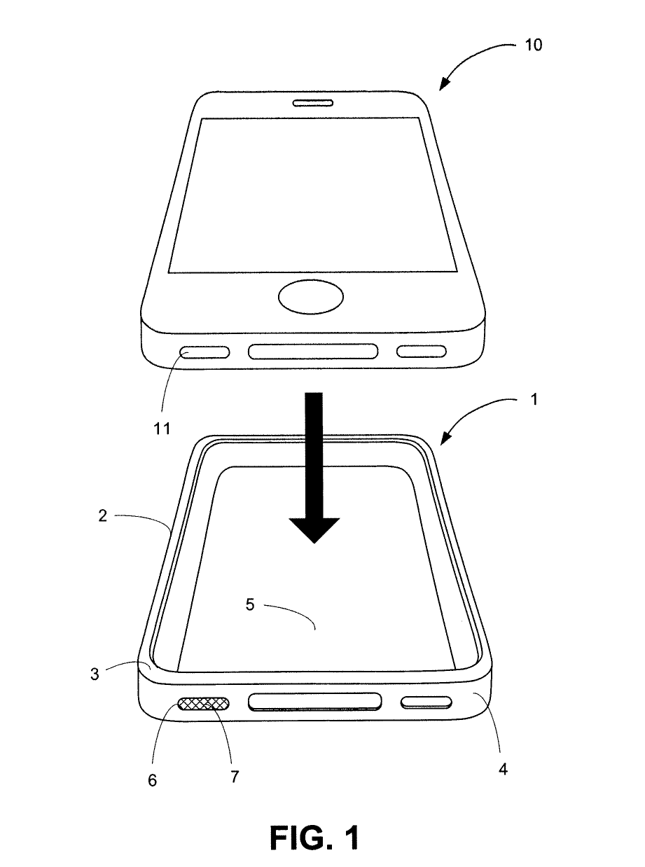

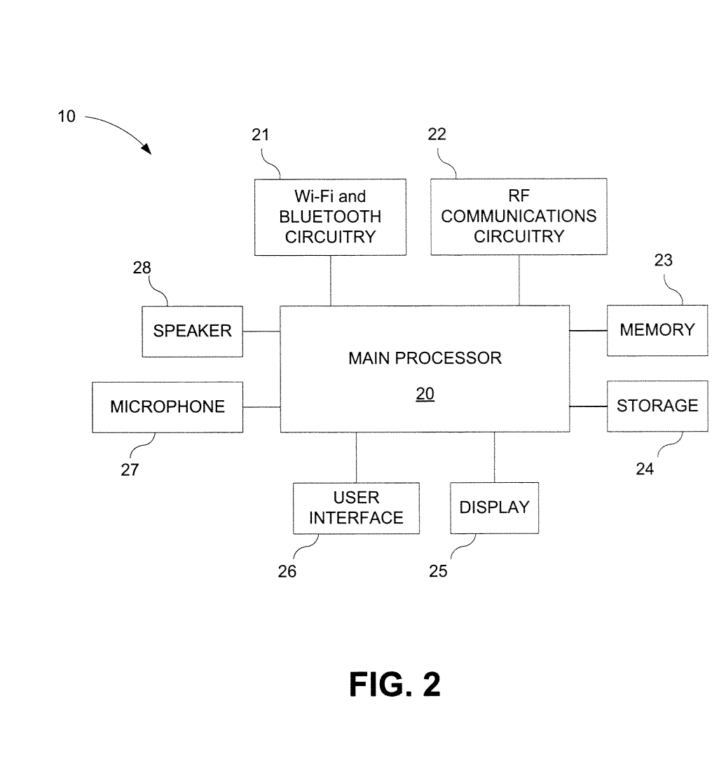

FIG. 1 shows an example removable case 1 (also referred to as a skin, bumper, or cover) for a handheld mobile communications device 10 according to an embodiment of the invention. The device 10 may be any handheld portable electronic device that enables its user to participate in a real-time two-way conversation, such as a cellular phone or a smart phone. The device 10 includes a microphone port 11 that enables the passage of sound, such as its user's speech, through its housing to an internal microphone (e.g., microphone 27 of FIG. 2) of the device 10.

FIG. 2 is an example block diagram of the mobile device 10 in which the removable case 1 may be installed. The mobile device 10 includes a main processor 20 that may interact with RF communications circuitry 22, Wi-Fi and Bluetooth circuitry 21, memory 23, storage 24, a speaker 28, a microphone 27, a display 5, and a user interface 26. The various components of the mobile device 10 may be digitally interconnected and used or managed by a software stack being executed by the main processor 20. Many of the components shown or described here may be implemented as one or more dedicated hardware units and/or a programmed processor (software being executed by a processor, e.g., the main processor 20).

The main processor 20 controls the overall operation of the mobile device 10 by performing some or all of the operations of one or more applications implemented on the mobile device 10, by executing instructions for it (software code and data) that may be found in the storage 24. The processor 20 may, for example, drive the display 25 and receive user inputs through the user interface 26 (which may be integrated with the display 25 as part of a single, touch sensitive display panel on the front face of the mobile device 10). The main processor 20 may also control the reception of forward channel signals and the transmission of reverse channel signals by the RF communications circuitry 22.

Storage 24 provides a relatively large amount of “permanent” data storage, using nonvolatile solid state memory (e.g., flash storage) and/or a kinetic nonvolatile storage device (e.g., rotating magnetic disk drive). Storage 24 may include both local storage and storage space on a remote server. Storage 24 may store data and software components that control and manage, at a higher level, the different functions of the mobile device 10. For instance, there may be telephony application that configures a built-in touch sensitive display to look like the keypad of a traditional telephony handset, and allows the user to enter a telephone number to be called, or select a previously stored number from a telephone address book. The telephony application then proceeds to allow the user to make a call, and controls the built-in microphone 27 and earpiece speaker 28 to enable the user to experience a two-way conversation during the call

In addition to storage 24, there may be memory 23, also referred to as main memory or program memory, which provides relatively fast access to stored code and data that is being executed by the main processor 20. Memory 23 may include solid state random access memory (RAM), e.g., static RAM or dynamic RAM. There may be one or more processors, e.g., main processor 20, that run or execute various software programs, modules, or sets of instructions (e.g., applications) that, while stored permanently in the storage 24, have been transferred to the memory 23 for execution, to perform the various functions described above. It should be noted that these modules or instructions need not be implemented as separate programs, but rather may be combined or otherwise rearranged in various combinations. In addition, the enablement of certain functions could be distributed amongst two or more modules, and perhaps in combination with certain hardware.

Referring again to FIG. 1, the removable case 1 includes a shell 2 that houses and provides protection to the mobile device 10 that is placed inside the case 1. The shell 2 may be formed from one or more materials such as plastic, acrylic, polycarbonate, silicon, or rubber. The shell 2 may have a front lip 3, a side wall 4, and a back wall 5. The shell 2 is dimensioned to yield a snug fit once installed onto the device 10. The front lip 3 may provide a securing mechanism for securing the mobile device 10 within the shell 2.

The shell 2 includes various openings or other pathways that allow access to switches and connectors and enable the passage of light and sound through the shell 2 to and from the mobile device 10. One such opening is an opening 6 that aligns with a microphone port 11 of the mobile device 10. The opening 6 enables the passage of sound through the case 1 to the microphone port 11 of the mobile device 10.

The removable case 1 includes a windscreen 7 that is placed across the opening 6. The windscreen 7 reduces wind noise, air blasts, vocal plosives, and other noise that may be picked up by the device's internal microphone along with the user's voice. The windscreen 7 may also protect against dirt, dust, liquids, and other particles from entering the microphone port 11 of the mobile device 10. The windscreen 7 may have a mesh structure, a foam structure, or a feather-like structure. The windscreen 7 may be made of a material that has an acoustic resistivity such that it reduces wind noise without significantly altering the user's voice. Examples of such material may be cloth, acoustic foam, porous plastics, or screen material.

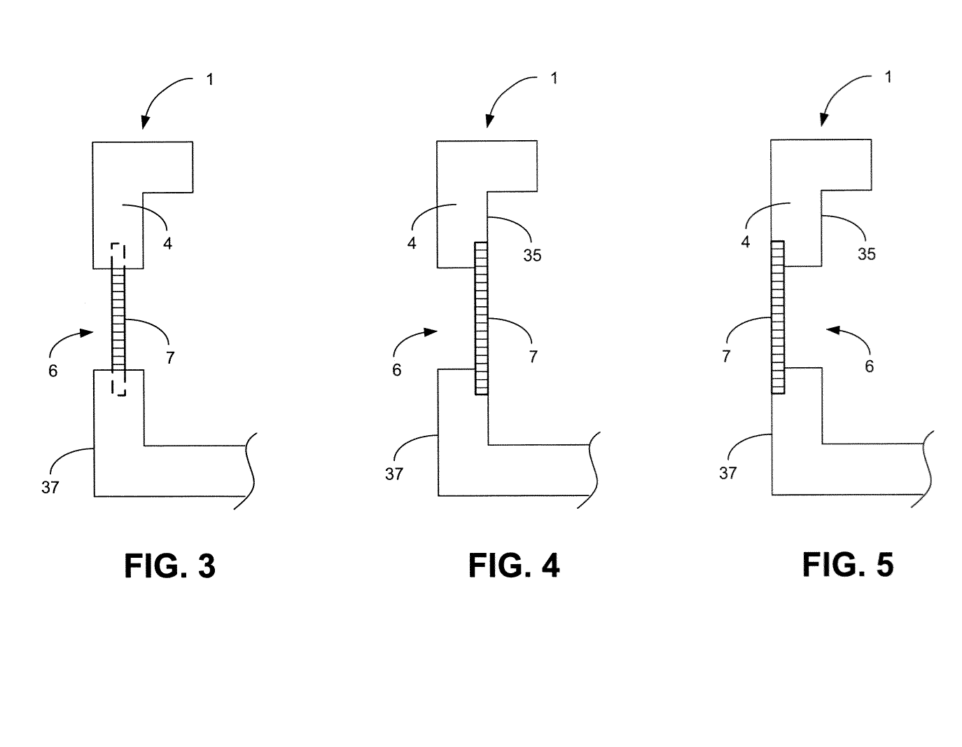

FIG. 3 is a cross-sectional view of the removable case 1 with the windscreen 7 according to an embodiment of the invention. The windscreen 7 in this embodiment is embedded in the side wall 4 of the case 1 such that it extends across the entirety of the opening 6 (or fills the opening 6) of the case 1 that aligns with a microphone port 11 of the device 10. The windscreen 7 may be embedded in the side wall 4 by, for example, integrally molding the windscreen 7 into the side wall 4 while molding the shell 2. Other methods of embedding the windscreen 7 into the side wall 4 may be used.

FIG. 4 is a cross-sectional view of the removable case 1 with the windscreen 7 according to another embodiment of the invention. The windscreen 7 in this embodiment is positioned on an interior (inside) surface 35 of the side wall 4 and adhesively attached to the interior surface 35. The interior surface 35 may have an indentation that surrounds the opening 6 (that aligns with a microphone port 11 of the device 10) in which the windscreen 7 may be placed. The windscreen 7 extends across the entirety of the opening 6 (or “sealed across” the opening 6). Other methods of positioning and attaching the windscreen 7 to the interior surface 35 of the side wall 4 may be used.

FIG. 5 is a cross-sectional view of the removable case 1 with the windscreen 7 according to another embodiment of the invention. The windscreen 7 in this embodiment is positioned on an exterior (outside) surface 37 of the side wall 4 and adhesively attached to the exterior surface 37. The exterior surface 37 may have an indentation that surrounds the opening 6 (that aligns with a microphone port 11 of the device 10) in which the windscreen 7 may be placed. The windscreen 7 extends across the entirety of the opening 6 (or “sealed across” the opening 6). Other methods of positioning and attaching the windscreen 7 to the exterior surface 37 of the side wall 4 may be used.

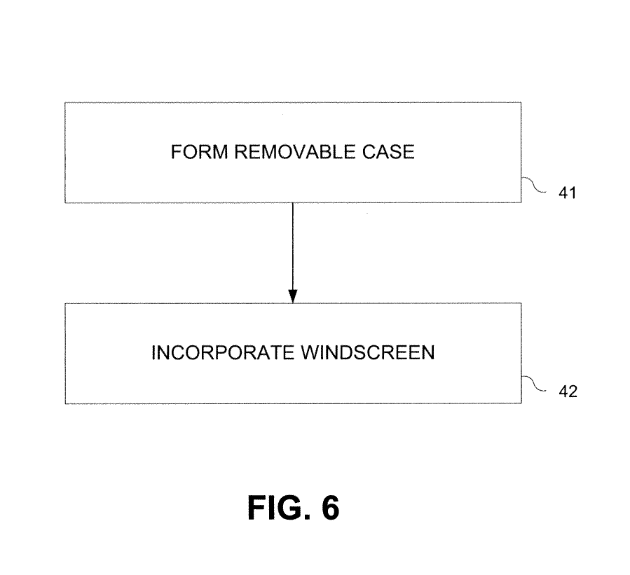

FIG. 6 is a flow chart of the operations performed to manufacture a windscreen equipped removable case for a mobile device. Manufacturing the removable case includes forming the removable case (in block 41) and incorporating the windscreen (in block 42). Forming the removable case may include selecting a positive model, e.g., a working or simulated mock-up of a mobile device, and forming a shell to the shape of the positive model. A shell may be formed to the shape of the positive model in any suitable manner, such as injection molding or thermal forming, using one or more materials that may include plastic, acrylic, polycarbonate, silicon, or rubber. An opening that aligns with the device's microphone port may be formed in the shell by, for example, cutting a hole through the shell at a location that correlates with the device's microphone port. Alternatively, the opening may be formed with the formation of the shell during the injection molding or thermal forming process. A windscreen may then be adhesively attached to an interior side of the shell around the opening (or to an exterior side thereof) so as to extend across the entire opening. Alternatively, the windscreen may be embedded into the wall of the shell or integrally molded into the shell so that it entirely fills the opening.

For purposes of explanation, specific embodiments were described to provide a thorough understanding of the present invention. These should not be construed as limiting the scope of the invention but merely as illustrating different examples and aspects of the invention. It should be appreciated that the scope of the invention includes other embodiments not discussed in detail above. Various other modifications, changes, and variations which will be apparent to those skilled in the art may be made in the arrangement, operation, and details of the apparatus and methods of the present invention disclosed herein without departing from the spirit and scope of the invention as defined in the appended claims. For instance, while FIG. 3 shows the side wall 4 of the case 1 as being a single layer of material with the windscreen 7 embedded within it, an alternative is to have the side wall 4, or the shell 2 (see FIG. 1) be made of two layers of material and where the windscreen 7 is embedded between the two layers. Therefore, the scope of the invention should be determined by the claims and their legal equivalents. Such equivalents include both currently known equivalents as well as equivalents developed in the future, i.e., any elements developed that perform the same function, regardless of structure. Furthermore, no element, component, or method step is intended to be dedicated to the public regardless of whether the element, component, or method step is explicitly recited in the claims.

What is claimed is:

1. An apparatus, comprising:
a removable case for a handheld mobile communications device having a windscreen sealed across an opening of the case, wherein the opening aligns with a microphone port that is built into the device.

2. The apparatus of claim 1, wherein the case is formed from at least one of plastic, acrylic, polycarbonate, silicon, or rubber.

3. The apparatus of claim 1, wherein the windscreen has a structure that includes at least one of a mesh structure, a foam structure, or a feather-like structure.

4. The apparatus of claim 1, wherein the windscreen is adhesively attached to an interior side of the case so as to extend across the opening.

5. The apparatus of claim 1, wherein the windscreen is embedded in a wall of the case so as to extend across the opening.

6. The apparatus of claim 1, wherein the windscreen is molded integrally into the case so as to extend across the opening.

7. The apparatus of claim 1, wherein the windscreen reduces susceptibility of a microphone to wind noise.

8. The apparatus of claim 1, wherein the windscreen prevents moisture, dirt, or dust from entering the microphone port.

9. A removable case for a handheld mobile communications device, comprising:
an opening that aligns with the device's built-in microphone port; and
a windscreen that fills the opening.

10. The removable case of claim 9, wherein the case is formed from at least one of plastic, acrylic, polycarbonate, silicon, or rubber.

11. The removable case of claim 9, wherein the windscreen has a structure that includes at least one of a mesh structure, a foam structure, or a feather-like structure.

12. The removable case of claim 9, wherein the windscreen is adhesively attached to an interior side of the case so as to extend across the opening.

13. The removable case of claim 9, wherein the windscreen is embedded in a wall of the case so as to extend across the opening.

14. The removable case of claim 9, wherein the windscreen is molded integrally into the case so as to extend across the opening.

15. The removable case of claim 9, wherein the windscreen reduces susceptibility of a microphone to wind noise.

16. The removable case of claim 9, wherein the windscreen prevents moisture, dirt, or dust from entering the microphone port.

17. A method, comprising:
forming a removable case for a handheld mobile communications device, wherein the removable case includes an opening that aligns with the device's built-in microphone port; and
incorporating a windscreen into the case, wherein the windscreen fills the opening of the case.

18. The method of claim 17, wherein forming the case includes forming the case from at least one of plastic, acrylic, polycarbonate, silicon, or rubber.

19. The method of claim 17, wherein incorporating the windscreen includes incorporating a structure that includes at least one of a mesh structure, a foam structure, or a feather-like structure.

20. The method of claim 17, wherein incorporating the windscreen includes adhesively attaching the windscreen to an interior side of the case so as to extend across the opening.

21. The method of claim 17, wherein incorporating the windscreen includes embedding the windscreen in a wall of the case so as to extend across the opening.

22. The method of claim 17, wherein incorporating the windscreen includes integrally molding the windscreen into the case so as to extend across the opening.

23. The method of claim 17, wherein the windscreen reduces susceptibility of a microphone to wind noise.

24. The method of claim 17, wherein the windscreen prevents moisture, dirt, or dust from entering the microphone port.
